(19) United States
(12) Patent Application Publication
(10) Pub. No.: US 2008/0223373 A1
(43) Pub. Date: Sep. 18, 2008

(54) Pressure support respiration mask

(75) Inventor: Eric Chang, Taichung Hsien (TW)

Correspondence Address: LADAS & PARRY LLP, 224 SOUTH MICHIGAN AVENUE, SUITE 1600, CHICAGO, IL, 60604, US

(73) Assignee: HSINER CO., LTD.,, Taichung Hsien (TW)

(21) Appl. No.: 11/889,922

(22) Filed: Aug. 17, 2007

(30) Foreign Application Priority Data
Mar. 16, 2007 (TW) 096109094

(51) Int. Cl. A62B 18/08

(52) U.S. Cl. 128/206.24; 128/205.25

(57) ABSTRACT

A pressure support respiration mask includes an elastic cap body having: a front end wall that is formed with a front opening; a surrounding wall that extends rearwardly from a periphery of the front end wall in a transverse direction relative to the front end wall, that defines an inner space in fluid communication with the front opening, and that has a rear end; a skirt wall that flares outwardly of the inner space from a periphery of the rear end of the surrounding wall, and that has a rear end; and a rear end wall that is constricted from a periphery of the rear end of the skirt wall to define a rear opening.

### CROSS-REFERENCE TO RELATED APPLICATION

This application claims priority of Taiwanese Application No. 096109094, filed on Mar. 16, 2007.

### BACKGROUND OF THE INVENTION

1. Field of the Invention

The invention relates to a pressure support respiration mask, more particularly to a pressure support respiration mask having a skirt wall enlarged in cross-section from a surrounding wall for enhancing a sealing effect during use.

2. Description of the Related Art

FIG. 1 illustrates a conventional pressure support respiration apparatus that includes a gas supply 11, a gas conduit 12, an elastic pressure support respiration mask 13, and a pair of head straps 14. The gas conduit 12 is connected to the gas supply 11 so as to supply gas into a chamber 130 defined by walls of the pressure support respiration mask 13. The pressure support respiration mask 13 includes a front end wall 131 that is formed with a front opening for air inlet, a surrounding wall 132 extending rearwardly from the front end wall 131, and a rear end wall 135 constricted from the surrounding wall 132 to define a rear opening for extension of the nose of a wearer therethrough and into the chamber 130. By the pulling force of the head straps 14, the rear end wall 135 is able to abut sealingly against the surrounding of the nose so as to permit a positive pressure to be built in the chamber 130, thereby assisting in the breathing of the wearer.

The conventional pressure support respiration mask is disadvantageous in that the rear end wall 135 cannot provide a satisfactory sealing unless the head straps 14 are tightly worn, which results in wearer discomfort when the straps 14 are tightly fastened and which results in air leakage when the straps 14 are loosely fastened.

### SUMMARY OF THE INVENTION

Therefore, the object of the present invention is to provide a pressure support respiration mask that can overcome the aforesaid drawbacks associated with the prior art.

According to the present invention, there is provided a pressure support respiration mask including an elastic cap body having: a front end wall that is formed with a front opening; a surrounding wall that extends rearwardly from a periphery of the front end wall in a transverse direction relative to the front end wall, that defines an inner space in fluid communication with the front opening, and that has a rear end; a skirt wall that flares outwardly of the inner space from a periphery of the rear end of the surrounding wall, and that has a rear end; and a rear end wall that is constricted from a periphery of the rear end of the skirt wall to define a rear opening adapted for extension of the nose of a wearer therethrough and into the inner space.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic partly sectional view of a conventional pressure support respiration mask;

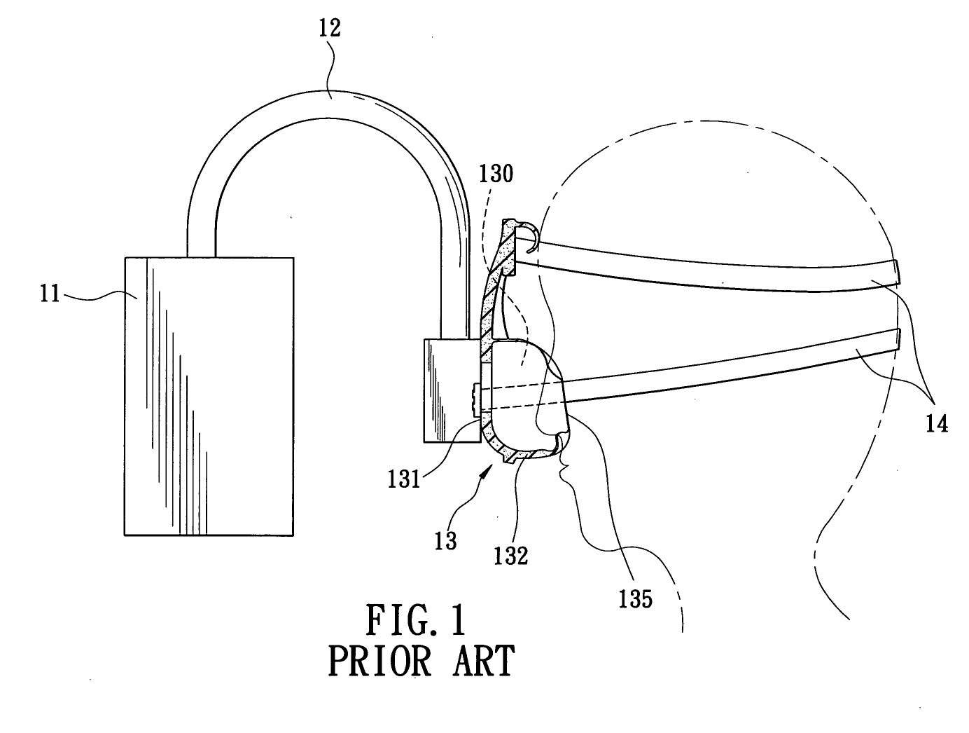

FIG. 2 is a sectional view of the preferred embodiment of a pressure support respiration mask according to the present invention;

FIG. 3 is another sectional view of the preferred embodiment; and

FIG. 4 is a schematic view illustrating the preferred embodiment in a state of use.

### DETAILED DESCRIPTION OF THE PREFERRED EMBODIMENT

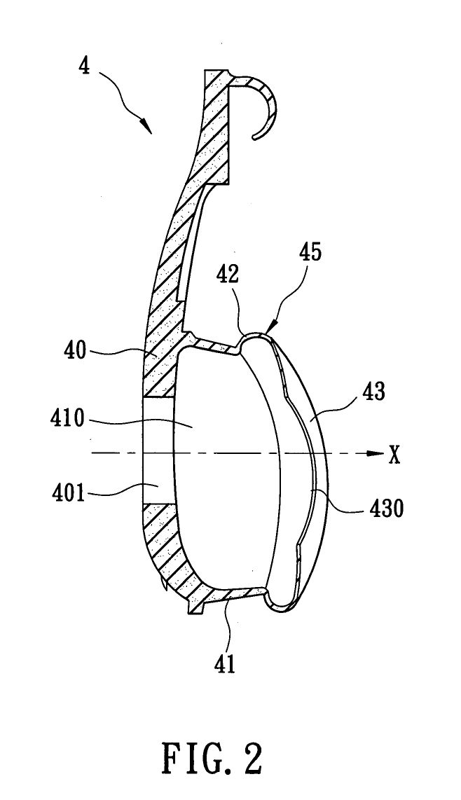

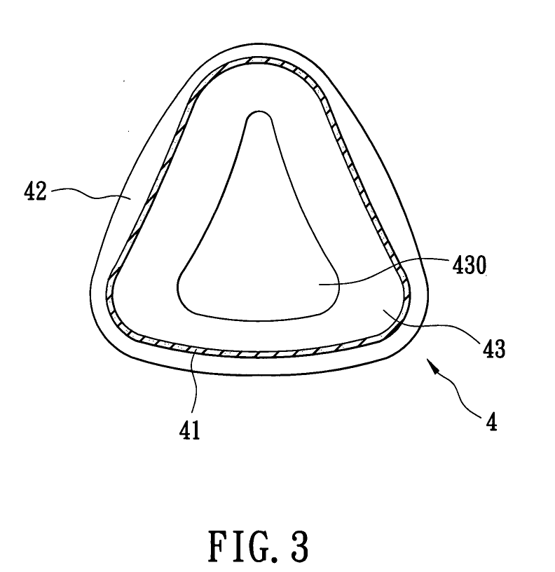

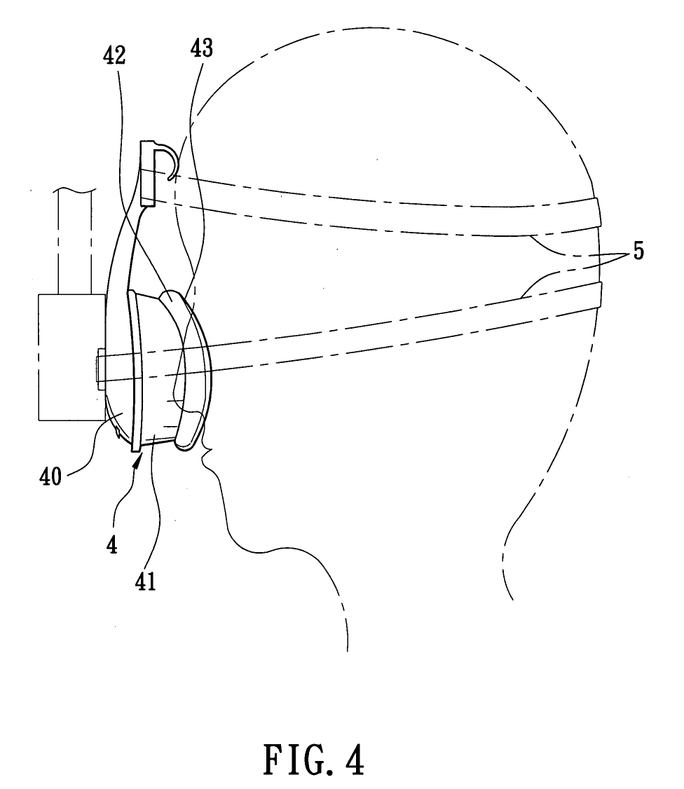

Referring to FIGS. 2, 3 and 4, the preferred embodiment of a pressure support respiration mask according to the present invention is shown to include an elastic cap body 4 and a pair of straps 5 connected to the cap body 4.

The cap body 4 is generally triangular in shape with rounded vertices, and includes: a front end wall 40 that is formed with a front opening 401; a surrounding wall 41 that extends rearwardly from a periphery of the front end wall 40 in a transverse direction (X) relative to the front end wall 40, that defines an inner space 410 in fluid communication with the front opening 401, and that has a rear end; a skirt wall 42 that flares outwardly of the inner space 410 from a periphery of the rear end of the surrounding wall 41, and that has a rear end; and a rear end wall 43 that is constricted from a periphery of the rear end of the skirt wall 42 to define a rear opening 430 adapted for extension of the nose of a wearer therethrough and into the inner space 410, and that is aligned with the front end wall 40 in the transverse direction (X). The skirt wall 42 cooperates with the rear end wall 43 to form a pleated part 45 of the cap body 4 that is elastically expandable and contractable in the transverse direction (X), thereby providing a cushioning effect and enhancing the sealing between the rear end wall 43 and the surrounding of the nose when the cap body 4 is pulled by the straps 5.

With the inclusion of the pleated part 45 in the cap body 4 of the pressure support respiration mask of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pressure support respiration mask comprising:
an elastic cap body having
a front end wall that is formed with a front opening,
a surrounding wall that extends rearwardly from a periphery of said front end wall in a transverse direction relative to said front end wall, that defines an inner space in fluid communication with said front opening, and that has a rear end,
a skirt wall that flares outwardly of said inner space from a periphery of said rear end of said surrounding wall, and that has a rear end, and
a rear end wall that is constricted from a periphery of said rear end of said skirt wall to define a rear opening adapted for extension of the nose of a wearer therethrough and into said inner space.

2. The pressure support respiration mask as claimed in claim 1, wherein said skirt wall cooperates with said rear end wall to define a pleated part that is elastically expandable and contractable in the transverse direction.

3. The pressure support respiration mask as claimed in claim 1, wherein said elastic cap body is generally triangular in shape with rounded vertices.
